(19) United States
(12) Patent Application Publication
(10) Pub. No.: US 2026/0120973 A1
(43) Pub. Date: Apr. 30, 2026

(54) ILLUMINATED KEY

(71) Applicant: Primax Electronics Ltd., Taipei (TW)

(72) Inventors: Chuang-Shu Jhuang, Taipei (TW); Zhi-Hui Zeng, Taipei (TW); Lei-Lung Tsai, Taipei (TW)

(21) Appl. No.: 18/942,913

(22) Filed: Nov. 11, 2024

(30) Foreign Application Priority Data
Oct. 28, 2024 (CN) 202411514928.1

(51) Int. Cl. H01H 13/02; H01H 13/04; H01H 13/10; H01H 13/14; H01H 13/52

(52) U.S. Cl. CPC H01H 13/023; H01H 13/04; H01H 13/10; H01H 13/14; H01H 13/52

(57) ABSTRACT

An illuminated key includes an integrated structure, a base plate and a key structure. The integrated structure includes a membrane layer, a backlight component and a spacer layer. A lower surface of the membrane layer is provided with first and second conductive patterns separated from each other. The backlight component is disposed beneath the membrane layer. An upper surface of the backlight component is provided with a conductive pad, and the first and second conductive patterns and the conductive pad constitute a key switch, and the backlight component is a light guide plate or a lamp board. The spacer layer is disposed between the membrane layer and the backlight component. The base plate is disposed over the integrated structure and has an opening. The key structure is disposed over the base plate and has an elastic member disposed in the opening of the base plate.

### FIELD OF THE INVENTION

The present invention relates to an illuminated key, and in particular, to an illuminated key including an integrated structure having both a membrane switch function and a light-emitting function.

### BACKGROUND OF THE INVENTION

A keyboard is an indispensable device for people to use computers. The keyboard is provided with many keys for users to press to input commands. With the improvement of keyboards, a keyboard with a backlight module is now available. However, such keyboard has the backlight module, so its overall weight is heavier and its overall thickness is thicker, making it difficult to meet today's needs. Therefore, how to improve the aforementioned situation has become a technical issue in this field.

### SUMMARY OF THE INVENTION

The present invention provides an illuminated key, which includes an integrated structure, a base plate and a key structure. The integrated structure includes a membrane layer, a backlight component and a spacer layer. A lower surface of the membrane layer is provided with a first conductive pattern and a second conductive pattern that are separated from each other. The backlight component is disposed beneath the membrane layer. An upper surface of the backlight component is provided with a conductive pad corresponding to the first conductive pattern and the second conductive pattern, and the first conductive pattern, the second conductive pattern and the conductive pad constitute a key switch, and the backlight component is a light guide plate or a lamp board. The spacer layer is disposed between the membrane layer and the backlight component. The base plate is disposed over the integrated structure and has an opening. The key structure is disposed over the base plate and has an elastic member disposed in the opening of the base plate.

In some embodiments of the present invention, the elastic member is fixed on the membrane layer.

In some embodiments of the present invention, the illuminated key further includes an insulating layer disposed between the membrane layer and the base plate, and the elastic member being fixed on the insulating layer.

In some embodiments of the present invention, the integrated structure further includes a light reflective layer disposed beneath the backlight component.

In some embodiments of the present invention, a lower surface of the spacer layer is provided with a light-shielding layer and a reflective coating in sequence, and the upper surface of the backlight component is further provided with a varnish layer.

The present invention also provides an illuminated key, which includes an integrated structure, a key structure and a base plate. The integrated structure includes a membrane circuit board and a light-emitting element. The light-emitting element is disposed on an upper surface of the membrane circuit board. The key structure is disposed over the integrated structure and has an elastic member. The base plate is disposed beneath the integrated structure or between the key structure and the integrated structure, and has an opening corresponding to the elastic member.

In some embodiments of the present invention, the light-emitting element is a sub-millimeter light-emitting diode (mini LED).

In some embodiments of the present invention, the membrane circuit board includes: a first membrane layer; a second membrane layer, disposed over the first membrane layer, in which the light-emitting element is fixed on an upper surface of the second membrane layer; and a spacer layer, disposed between the first membrane layer and the second membrane layer.

In some embodiments of the present invention, a vertical projection of the opening is greater than a vertical projection of the elastic member.

In some embodiments of the present invention, the illuminated key further includes an insulating layer disposed between the elastic member and the membrane circuit board and having a first through hole and a second through hole adjacent to the first through hole, in which the elastic member corresponds to the first through hole and is fixed on the insulating layer, and the light-emitting element is disposed in the second through hole.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a three-dimensional exploded view of an illuminated key according to an embodiment of the present invention.

FIG. 2 is an enlarged view of a membrane layer of FIG. 1.

FIG. 3 is a cross-sectional view of the illuminated key of FIG. 1.

FIG. 4 is a three-dimensional exploded view of an illuminated key according to another embodiment of the present invention.

FIG. 5 is an enlarged view of a second membrane layer of a membrane circuit board and a light-emitting element of FIG. 4.

FIG. 6 is a cross-sectional view of the illuminated key of FIG. 4.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, the keyboard with the backlight module is heavier and thicker, making it difficult to meet today's needs. Accordingly, the present invention provides an illuminated key, which includes an integrated structure, a base plate and a key structure. The integrated structure includes a membrane layer, a backlight component (e.g., a light guide plate or a lamp board) and a spacer layer, or includes a membrane circuit board and a light-emitting element, so as to provide both a membrane switch function and a light-emitting function. This can help reduce an overall weight and an overall thickness of an illuminated keyboard. Various embodiments of the illuminated key of the present invention will be described in detail below.

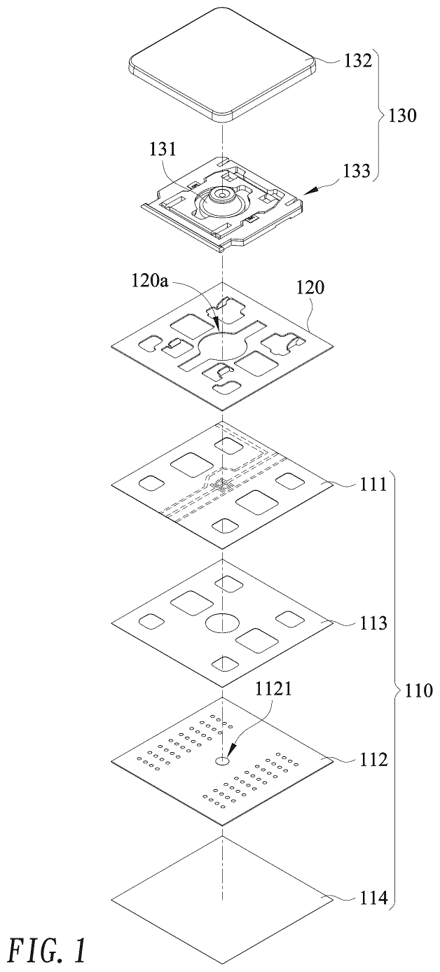

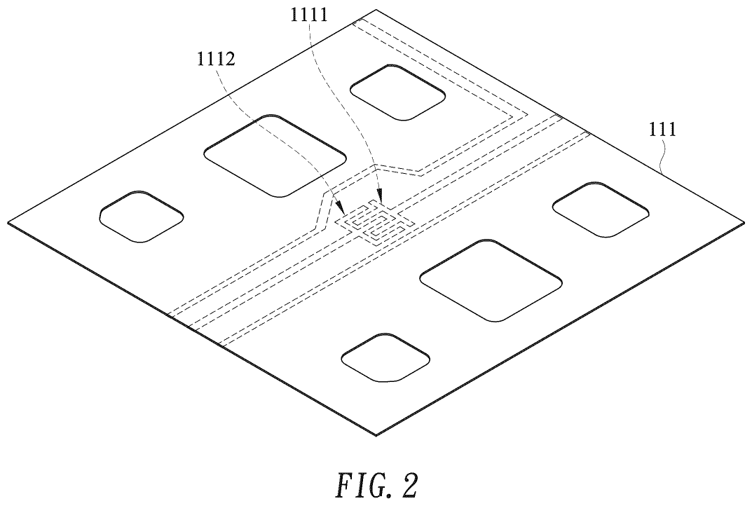

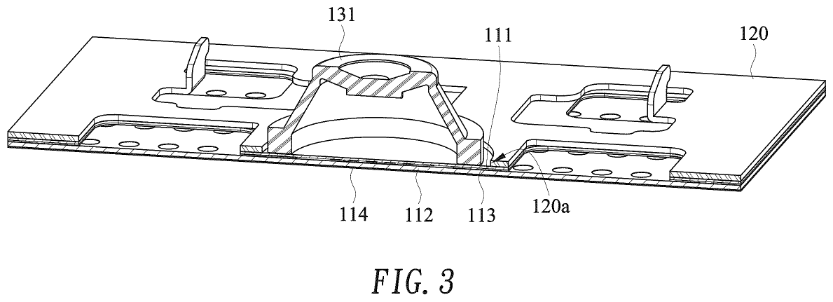

FIG. 1 is a three-dimensional exploded view of an illuminated key according to an embodiment of the present invention. FIG. 2 is an enlarged view of a membrane layer of FIG. 1. FIG. 3 is a cross-sectional view of the illuminated key of FIG. 1. As shown in FIG. 1, the illuminated key includes an integrated structure 110 that has both a membrane switch function and a light-emitting function, a base plate 120 and a key structure 130. As shown in FIGS. 1 to 3, the integrated structure 110 includes a membrane layer 111, a backlight component 112 and a spacer layer 113.

As shown in FIGS. 1 and 2, a first conductive pattern 1111 and a second conductive pattern 1112 separated from each other are provided on a lower surface of the membrane layer 111. The first conductive pattern 1111 and the second conductive pattern 1112 can be formed by printing silver paste. However, the present invention is not limited to the aforementioned embodiments. In some embodiments, upper and lower surfaces of the membrane layer 111 are provided with circuits, and the circuits can be connected through a through hole; further, an insulating layer can be provided to cover the circuits on the upper surface of the membrane layer 111 to protect the circuits.

The backlight component 112 is disposed beneath the membrane layer 111. A conductive pad 1121 corresponding to the first conductive pattern 1111 and the second conductive pattern 1112 is provided on an upper surface of the backlight component 112. The first conductive pattern 1111, the second conductive pattern 1112 and the conductive pad 1121 constitute a key switch. The conductive pad 1121 can be formed by printing silver paste.

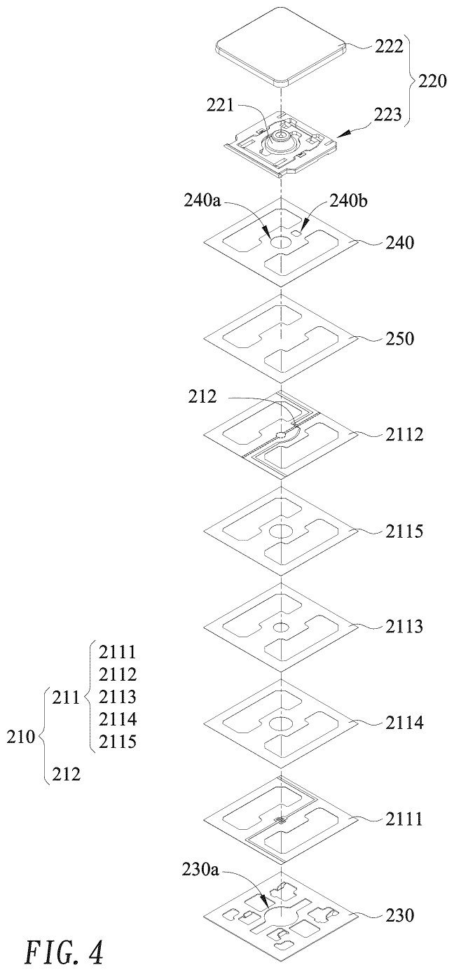

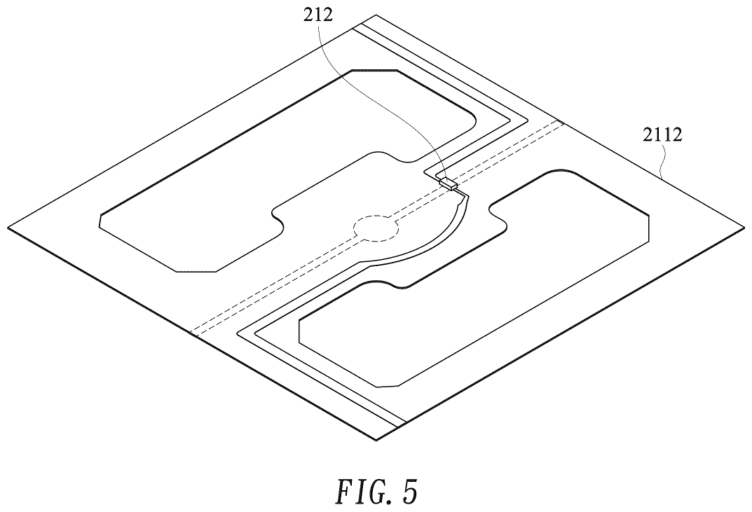

The backlight component 112 is a light guide plate (as shown in FIGS. 1 and 3) or a lamp board. In some embodiments, the lamp board includes an insulating layer and a light-emitting element and its circuit disposed thereon, such as a second membrane layer 2112, a light-emitting element 212 and its circuit shown in FIGS. 4 and 5. Each key can be configured with one light-emitting element. In some embodiments, the light-emitting element is a sub-millimeter light-emitting diode (mini LED).

The spacer layer 113 is disposed between the membrane layer 111 and the backlight component 112. The spacer layer 113 helps to make a triggering force of the first conductive pattern 1111 and the second conductive pattern 1112 to the conductive pad 1121 more stable to avoid heavy press or light touch problems. In some embodiments, the spacer layer 113 is a spacer layer, a UV insulating layer, or is made of another suitable insulating material.

In some embodiments, a lower surface of the spacer layer 113 is provided with a light-shielding layer (not shown) and a reflective coating (not shown) in sequence, and the upper surface of the backlight component 112 is further provided with a varnish layer (not shown) to improve light utilization.

Referring to FIGS. 1 to 3, when the key structure 130 is pressed, the elastic member 131 deforms, and a contact portion (not labeled) of the elastic member 131 is in contact with the membrane layer 111, causing the membrane layer 111 to protrude downward to allow the first conductive pattern 1111 and the second conductive pattern 1112 to be in contact with the conductive pad 1121, so that the first conductive pattern 1111 and the second conductive pattern 1112 are electrically conducted to each other to generate a signal.

It is worth noting that when the backlight component 112 is the light guide plate, the light guide plate can replace a lower membrane layer of a conventional membrane circuit board, and there is no need to dispose the lower membrane layer of the conventional membrane circuit board. Therefore, the illuminated key of the present invention is thinner and lighter. When the backlight component 112 is the lamp board, each key can be configured with one light-emitting element, and there is no need to set up a backlight module. As such, the illuminated keyboard can be lighter and thinner, and power consumption can be lower, and an assembly process can be simpler.

On the other hand, since the backlight component 112 is provided with the conductive pad 1121 instead of a large number of circuit patterns, a process yield of the backlight component 112 is high.

In some embodiments, when the backlight component 112 is the light guide plate, the integrated structure 110 further includes a light-emitting element (not shown) adjacent to a side surface of the light guide plate. When the light-emitting element emits light, the light enters the inside of the light guide plate from the side surface of the light guide plate. In some embodiments, as shown in FIGS. 1 and 3, an upper surface of the light guide plate has a plurality of light guide patterns (not labeled), so that the light can emit from areas where the light guide patterns are located.

In some embodiments, as shown in FIGS. 1 and 3, the integrated structure 110 further includes a light reflective layer 114, which is disposed beneath the backlight component 112 to improve light utilization.

As shown in FIGS. 1 and 3, the base plate 120 is disposed over the integrated structure 110 and has an opening 120a. In some embodiments, the opening 120a is composed of a circular opening and two strip-shaped openings extending to two opposite ends, respectively. However, the present invention is not limited thereto. In other embodiments, the opening 120a may have another suitable shape. In some embodiments, the base plate 120 further has a plurality of peripheral openings (not labeled) disposed around the opening 120a, and each of the peripheral openings exposes a portion of the backlight component 112.

The key structure 130 is disposed over the base plate 120. The key structure 130 has an elastic member 131 disposed in the opening 120a of the base plate 120. In some embodiments, a vertical projection of the opening 120a is greater than a vertical projection of the elastic member 131.

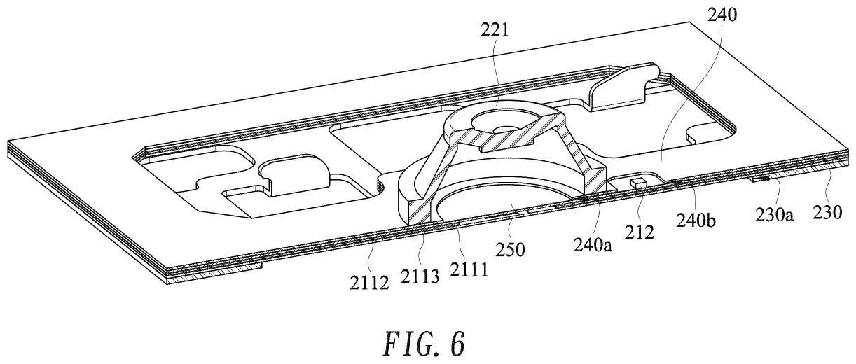

In some embodiments, as shown in FIG. 3, the elastic member 131 is fixed on the membrane layer 111. However, the present invention is not limited thereto. In other embodiments, the illuminated key further includes an insulating layer (e.g., an insulating layer 240 shown in FIGS. 4 and 6), which is disposed between the membrane layer 111 and the base plate 120, and the elastic member 131 is fixed on the insulating layer. The insulating layer may be, for example, Mylar. In some embodiments, as shown in FIG. 1, the key structure 130 further includes a keycap 132 and a scissor-type connecting element 133 connected between the keycap 132 and the base plate 120.

FIG. 4 is a three-dimensional exploded view of an illuminated key according to another embodiment of the present invention. FIG. 5 is an enlarged view of a second membrane layer of a membrane circuit board and a light-emitting element of FIG. 4. FIG. 6 is a cross-sectional view of the illuminated key of FIG. 4. As shown in FIGS. 4 to 6, the illuminated key includes an integrated structure 210, a key structure 220 and a base plate 230.

The integrated structure 210 includes a membrane circuit board 211 and a light-emitting element 212. Each key can be configured with one light-emitting element 212, so there is no need to set up a backlight module. As such, the illuminated keyboard can be lighter and thinner, and power consumption can be lower, and an assembly process can be simpler.

In some embodiments, the membrane circuit board 211 includes a first membrane layer 2111, a second membrane layer 2112 and a spacer layer 2113. The second membrane layer 2112 is disposed over the first membrane layer 2111. The spacer layer 2113 is disposed between the first membrane layer 2111 and the second membrane layer 2112. As shown in FIGS. 4 and 5, a conductive pad (not labeled) is provided on a lower surface of the second membrane layer 2112, and a light-emitting element 212 and its circuit are provided on an upper surface thereof. As shown in FIG. 4, a first conductive pattern (not labeled) and a second conductive pattern (not labeled) are provided on an upper surface of the first membrane layer 2111. The conductive pad, the first conductive pattern and the second conductive pattern constitute a key switch. The conductive pad, the first conductive pattern and the second conductive pattern can be formed by printing silver paste. In some embodiments, a first glue layer 2114 may be disposed between the first membrane layer 2111 and the spacer layer 2113, and a second glue layer 2115 may be disposed between the spacer layer 2113 and the second membrane layer 2112.

The light-emitting element 212 is disposed on an upper surface of the membrane circuit board 211. As shown in FIGS. 4 to 6, the light-emitting element 212 is fixed on the upper surface of the second membrane layer 2112. In some embodiments, the light-emitting element is a sub-millimeter light-emitting diode (mini LED), which is very power-saving.

The key structure 220 is disposed over the integrated structure 210 and has an elastic member 221. In some embodiments, as shown in FIG. 4, the key structure 220 further includes a keycap 222 and a scissor-type connecting element 223 connected between the keycap 222 and the base plate 230.

The base plate 230 is disposed beneath the integrated structure 210 (as shown in FIGS. 4 to 6) or between the key structure and the integrated structure (refer to FIGS. 1 and 3), and has an opening 230a corresponding to the elastic member 221. In some embodiments, a vertical projection of the opening 230a is greater than a vertical projection of the elastic member 221. In some embodiments, the opening 230a is composed of a circular opening and two strip-shaped openings extending to two opposite ends, respectively. However, the present invention is not limited thereto. In other embodiments, the opening 230a may have another suitable shape.

Referring to FIG. 6, when the key structure 220 is pressed, the elastic member 221 deforms, and a contact portion (not labeled) of the elastic member 221 is in contact with the second membrane layer 2112, causing the second membrane layer 2112 to protrude downward to allow the conductive pad be in contact with the first conductive pattern and the second conductive pattern, so that the first conductive pattern and the second conductive pattern are electrically conducted to each other to generate a signal.

It is worth noting that due to a large size of the opening 230a of the base plate 230, the contact portion of the elastic member 221 can be further pressed down so that the first membrane layer 2111 also protrudes downward, which can provide a longer key travel distance to meet today's needs for the key travel distance.

In some embodiments, the illuminated key further includes an insulating layer 240, which is disposed between the elastic member 221 and the membrane circuit board 211, and has a first through hole 240a and a second through hole 240b adjacent to the first through hole 240a, in which the elastic member 221 corresponds to the first through hole 240a and is fixed on the insulating layer 240, and the light-emitting element 212 is disposed in the second through hole 240b. The insulating layer 240 may be, for example, Mylar.

In some embodiments, the illuminated key further includes a protective layer 250 disposed on the second membrane layer 2112 to protect peripheral circuits of the light-emitting element 212 therebeneath.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. An illuminated key, comprising:
an integrated structure, comprising:
a membrane layer, wherein a lower surface of the membrane layer is provided with a first conductive pattern and a second conductive pattern that are separated from each other;
a backlight component, disposed beneath the membrane layer, wherein an upper surface of the backlight component is provided with a conductive pad corresponding to the first conductive pattern and the second conductive pattern, and the first conductive pattern, the second conductive pattern and the conductive pad constitute a key switch, and the backlight component is a light guide plate or a lamp board; and
a spacer layer, disposed between the membrane layer and the backlight component; and
a base plate, disposed over the integrated structure and having an opening; and
a key structure, disposed over the base plate and having an elastic member disposed in the opening of the base plate.

2. The illuminated key of claim 1, wherein the elastic member is fixed on the membrane layer.

3. The illuminated key of claim 1, further comprising:
an insulating layer, disposed between the membrane layer and the base plate, and the elastic member being fixed on the insulating layer.

4. The illuminated key of claim 1, wherein the integrated structure further comprises:
a light reflective layer, disposed beneath the backlight component.

5. The illuminated key of claim 1, wherein a lower surface of the spacer layer is provided with a light-shielding layer and a reflective coating in sequence, and the upper surface of the backlight component is further provided with a varnish layer.

6. An illuminated key, comprising:
an integrated structure, comprising:
a membrane circuit board; and
a light-emitting element, disposed on an upper surface of the membrane circuit board;
a key structure, disposed over the integrated structure and having an elastic member; and
a base plate, disposed beneath the integrated structure or between the key structure and the integrated structure, and having an opening corresponding to the elastic member.

7. The illuminated key of claim 6, wherein the light-emitting element is a sub-millimeter light-emitting diode (mini LED).

8. The illuminated key of claim 6, wherein the membrane circuit board comprises:
a first membrane layer;
a second membrane layer, disposed over the first membrane layer, wherein the light-emitting element is fixed on an upper surface of the second membrane layer; and
a spacer layer, disposed between the first membrane layer and the second membrane layer.

9. The illuminated key of claim 6, wherein a vertical projection of the opening is greater than a vertical projection of the elastic member.

10. The illuminated key of claim 6, further comprising:
an insulating layer, disposed between the elastic member and the membrane circuit board, and having a first through hole and a second through hole adjacent to the first through hole, wherein the elastic member corresponds to the first through hole and is fixed on the insulating layer, and the light-emitting element is disposed in the second through hole.
